(19) United States
(12) Patent Application Publication
(10) Pub. No.: US 2006/0281659 A1
(43) Pub. Date: Dec. 14, 2006

(54) Process for producing a powder consisting of sodiumsesquicarbonate and layered silicate

(75) Inventors: Seung-Hak Baik, Gyeonggi-do (KR); Jae-Hong Lee, Seoul (KR)

Correspondence Address: FAEGRE & BENSON LLP;PATENT DOCKETING, 2200 WELLS FARGO CENTER, 90 SOUTH 7TH STREET, MINNEAPOLIS, MN, 55402-3901, US

(73) Assignee: Clenvi Co., Ltd.

(21) Appl. No.: 10/565,406

(22) PCT Filed: Jul. 22, 2003
(86) PCT No.: PCT/KR03/01456

§ 371 Date: Jul. 14, 2006

(51) Int. Cl. C11D 17/00

(52) U.S. Cl. 510/446

(57) ABSTRACT

The object of the present invention is to provide a process of producing powder consisting of sodium sesquicarbonate and layered silicate, which includes (a) mixing a sodium silicate aqueous solution with a separately prepared sodium bicarbonate aqueous solution to produce a reaction solution, or mixing sodium silicate, sodium bicarbonate, and water with each other to produce a reaction solution, (b) heating the reaction solution to form slurry, and (c) drying the slurry to produce the powder. The process according to the present invention can simultaneously produce sodium sesquicarbonate and layered silicate easily at high yield. Furthermore, sodium sesquicarbonate contained in powder produced according to the process of the present invention has desirable quality regarding crystalline structure, particle size and density.

### TECHNICAL FIELD

The present invention relates to a process of producing a builder applied to a detergent More particularly, the present invention pertains to a process of producing powder which is used as a builder of a detergent and consists of sodium sesquicarbonate and layered silicate.

### BACKGROUND ART

A surfactant and a builder are two important components constituting a detergent. In this regard, the builder is a material used to improve detergency of the detergent in that it softens hard water into soft water, provides alkali, and reduces surface action of the detergent to substantially assist the washing function of the surfactant. Additionally, the builder finely breaks the contaminants float and disperse, thereby preventing laundry from being re-stained and significantly improving the washing function. Representative examples of builders used in detergent include sodium sesquicarbonate and layered silicate.

One of the important processes of commercially producing sodium sesquicarbonate is to recover it from a trona ore expressed by the experimental equation Na₂CO₃.NaHCO₃.2H₂O. Natural trona ore consists mostly of sodium sesquicarbonate, about 90% on a dry basis. Natural trona may additionally contain impurities such as iron and organics.

A process of producing sodium sesquicarbonate by purifying the trona ore is disclosed in Chinese Pat No. 1,270,926, and in U.S. Pat. Nos. 2,346,140, 2,639,217, 3,028,215, 3,780,160, 6,207,123, and 200/0001037. However, sodium sesquicarbonate powder produced according to the process has undesirable quality regarding crystalline structure, particle size, and density. Accordingly, in order to improve the quality, U.S. Pat. No. 2,954,282 suggests re-crystallization of sodium sesquicarbonate employing miscellaneous synthetic surfactants, and Chinese Pat No. 1270926 proposes re-crystallization of sodium sesquicarbonate employing an anionic surfactant. Another process of producing sodium sesquicarbonate includes mining anhydrous soda ash, acid, water and the like with each other in a predetermined mixing ratio, and reacting the resulting mixture at 90° C. or below, as disclosed in U.S. Pat. No. 5,151,208. Another process is disclosed in International Pat. Publication No. WO 93121292, in which anhydrous soda ash and sodium bicarbonate react in a predetermined ratio in water to produce sodium sesquicarbonate.

Examples of layered silicate used in detergent include Natosilite (δ-silicate), Kanemite (NaHSi₂O₅.3H₂O), Makatite (Na₂Si₄O₉.3H₂O); Magadiite (Na₂Si₁₄O₂₉.11H₂O), Saponite, Kenyaite, Hectorite, and SKS 1-18(δ-silicate). All of the above substances have a layered structure, Saponite and Hectorite belong to a smectite-based clay, and the remaining substances are layered sodium silicate.

Most conventional processes of producing layered silicate include reacting sodium silicate at 500-1200° C., and require high production costs because they adopt a calcination process. For example, U.S. Pat. Nos. 4,581,213, 4,4585,642, 4,664,839, 4,806,327, 4,820,439,4,950,310, 5,456,895, and 5,874,397, and EP 0425428 and EP 0563361 disclose δ-silicate-based layered silicate, and adopt a process of producing layered silicate which includes heating amorphous sodium silicate at about 700° C. for about 1 hour to cystallize it.

Furthermore, U.S. Pat. Nos. 5,614,160, 5,643,358, and 5,776,893 disclose hydrated layered silicate as Kanemites, and a technology of producing a composite of Kanemite and amorphous sodium silicate which includes preparing silicate from amorphous sodium silicate and treating silicate in acid or alkaine solutions. As well, a document [C. Y. Chen, S. Q. Xiao, and M. E. Davis, ‘Studies on ordered mesoporous materials III. Comparison of MCM-41 tomesoporous materials derived from Kanemites, Microporous Materials, 4, 1-20 (1995)] discloses a technology of producing Kanemite which includes dispersing SiO₂ (1 mole) in 200-900 ml of methanol, adding 1 mole of NaOH (50% aqueous solution) to the resulting methanol at low temperature to form a gel drying the gel at 100° C. to produce an opaque material, and calcinating the opaque material at 700° C. for 5.5 hours. As well, U.S. Pat. No. 4,664,839 describes a process of producing Kanemite which includes dispersing δ-silicate in water to produce a solid, and filtering and drying the solid. Additionally, U.S. Pat. No. 5,456,895 discloses a technology of synthesizing a material having a Kanemite structure which includes reacting δ-silicate SKS-6 and precipitated silica in an aqueous solution at 60° C. for 8 hours. Furthermore, U.S. Pat. No. 5,767,061 discloses a technology of synthesizing a material having a Kanemite structure which includes adding a hydrochloric acid solution to δ-silicate, filtering the resulting solution, and drying the filtered material.

Furthermore, JP007322A2 describes a process of producing Makatite-based layered silicate which includes crystallizing sodium silicate in the presence of anhydrous soda ash, a Makatite seed nucleus, and water at 60-150° C. without agitation.

Furthermore, Korean Pat Laid-Open Publication No. 2001-0082782 discloses that amorphous sodium silicate reacts in an aqueous solution of anhydrous soda ash, sodium bicarbonate, or a mixture thereof in the presence of a synthetic surfactant, bentonite, silica and the like at 150° C. for 2 hours to produce Kanemite-based layered silicate. In detail, example 21 describes the reaction of third sodium silicate with anhydrous soda ash, sodium bicarbonate, bentonite, powdery silica, lauric acid, acryl-based polymer dispersing agent, and water while they are agitated at 150° C. to produce Kanemite-based layered silicate and sodium sesquicarbonate. In such a case, a great amount of hydrated soda ash is generated at an upper part of a reactor whereas sodium sesquicarbonate is detected only a small amount. During operation of the reactor, there are three different phases in the reactor, that is to say, a solid phase is formed at the upper part of the reactor, and two immiscible phases of liquid and slurry are formed at a lower part of the reactor, and thus, a very low yield results. In this regard, three phases separated from each other undesirably bring about a complicated process.

### DISCLOSURE OF THE INVENTION

The present inventors mixed and reacted aqueous solutions, in which sodium bicarbonate and sodium silicate are homogenized in water, with each other to produce slurry, dried the slurry to produce powder, and analyzed the powder using an XRD, resulting in the surprising finding that the powder consists of layered silicate and sodium sesquicarbonate. Particularly, SEM (scanning electron microscope) analysis of the powder confirmed that detected sodium sesquicarbonate has desirable quality regarding crystalline structure, particle size and density even though a seed nucleus or an anionic surfactant is not employed (FIG. 2).

Accordingly, an object of the present invention is to provide a process of producing powder including sodium sesquicarbonate and layered silicate, which includes (a) mixing a sodium silicate aqueous solution with a separately prepared sodium bicarbonate aqueous solution to produce a reaction solution, or mixing sodium silicate, sodium bicarbonate, and water with each other to produce a reaction solution, (b) heating the reaction solution to form slurry, and (c) drying the slurry to produce the powder.

### BRIEF DESCRIPTION OF THE DRAWINGS

FIG. 1 is an XRD analysis graph of a powder sample produced according to the present invention; and

FIG. 2 is an SEM picture of the powder sample produced according to the present invention.

### BEST MODE FOR CARRYING OUT THE INVENTION

Starting Material

Starting materials used in a process of the present invention are sodium bicarbonate and sodium silicate.

(1) Sodium Bicarbonate

Sodium carbonate (Na₂CO₃) is carbonated to produce sodium bicarbonate (R. N. Shreve et al., Chemical Process Industries, McGraw-Hill Book Co., 4^{th} ed., 1977, p.213). A commercial method of producing sodium bicarbonate includes dissolving soda ash (hydrated mineral matter mostly consisting of Na₂CO₃) in aqueous liquid, putting the resulting saturated solution of soda ash in a carbonation vessel to simultaneously cause the solution to come into contact with carbon dioxide gas and cool the solution. After aqueous slurry is recovered and filtered in the carbonation vessel it is dried to produce sodium bicarbonate crystals. Additionally, sodium bicarbonate may be produced from a trona ore (coarse sodium sesquicarbonate) through a multi-stage purifying process. Such a production is disclosed in U.S. Pat Nos. 2,346,140, 2,639,217, 3,028,215, 3,780,160, 6,207,123, and 200/0001037, and Chinese Pat. No. 1270926.

(2) Sodium Silicate

Sodium silicate is produced by reacting a mixture of silica with soda ash or caustic soda at 1200° C. or above, consists of SiO₂ and Na₂O, and forms various compounds according to the relative proportion of the above two components. It is usually classified into a crystal type and an amorphous type, and amorphous-type silicate is exemplified by sodium metasilicate, sodium orthosilicate, and sodium sesquisilicate, which respectively contain SiO₂ and Na₂O mixed in a molar ratio of 1:1, 1:2, and 2:3, and first to fourth liquid sodium silicates which contain from 30% to 50% water corresponding to a ratio of SiO₂ from 2 to 4. Commercial liquid sodium silicate contains SiO₂ and Na2O mixed in a ratio of about 2-4:1. Preferably, sodium silicate contains SiO₂ and Na₂O mixed in a ratio of 2.1-3.8:1.

In the middle of the process according to the present invention, an amount of water may be controlled to prevent formation of lumps which are considered an obstruction to the process, thereby increasing yield. According to a preferable aspect of the present invention, a ratio of solids to water is maintained at about 50-70% in mixed liquid of sodium bicarbonate with sodium silicate. In this regard, since sodium silicate essentially contains water, the amount of water added in practice is less than 50-70%. When the amount of water is small, a large amount of anhydrous soda ash may be generated. On the other hand, when the amount of water is large, the reaction of sodium silicate with sodium bicarbonate may be hindered. In other words, when separate reactions of sodium silicate and sodium bicarbonate occur, sodium silicate forms a transparent crystal and sodium bicarbonate is dissolved in water.

Products

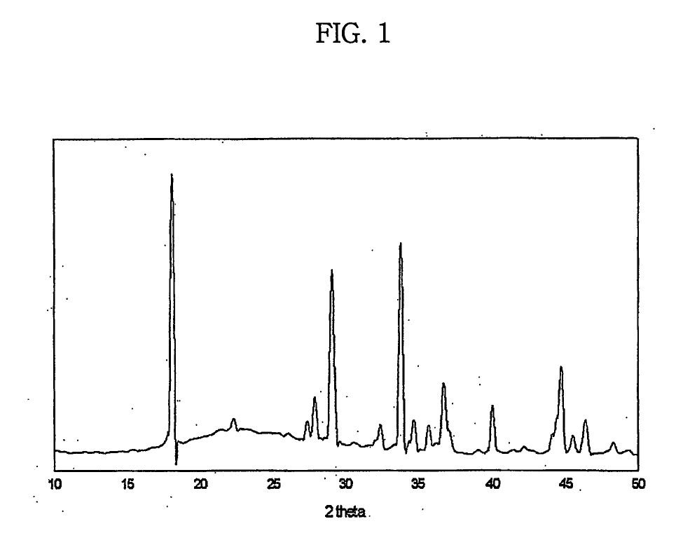

According to the present invention, sodium bicarbonate aqueous solution reacts with sodium silicate aqueous solution, and the resulting solution is dried to produce powder consisting of the following components (FIG. 1).

(1) Sodium Sesquicarbonate

Sodium sesquicarbonate is expressed as an experimental equation of NaCO₃.NaHCO₃.2H₂O, and is a crystal having an acicular structure in a powdery state. Sodium sesquicarbonate has some advantages as a component constituting a detergent composition. Particularly, sodium sesquicarbonate is advantageous in that it has excellent detergency and is nonpolluting. Another advantage is that it has a weak alkaline pH, thereby minimzing damage to a fiber. Due to the above advantages, Chinese Pat. No. 1176995, EP0653481, GB2315762, and GB2315764, and U.S. Pat Nos. 5,756,445 and 6,022,843 suggest sodium sesquicarbonate as the detergent composition.

(2) Layered Silicate

Layered silicate may be expressed as a Formula 1.
NaMSiₓO₂₊₁.yH₂O Formula 1

Wherein, M is sodium (Na) or hydrogen (H), x is 1.9-4, and y is 0-20. Usually, layered silicate has a structure provided in two-dimensional sheets, that is to say, δ-sheet structure. Since various sizes of inorganic ions can be exchanged between the sheets and organic polymer materials can be inserted between the sheets, layered silicate is desirably capable of removing hardness components from water and has excellent sorptivity to contaminants during a washing process, and thus, it has physical properties suitable as a builder for detergent. Furthermore, since it has excellent capability to enable oil to be absorbed into a surfactant, the amount of surfactant used in a detergent may be reduced during a compounding of the detergent. Particularly, when layered silicate is used as the builder for detergent disadvantages of aluminosilicate zeolite A, which was frequently used as the builder for detergent after the use of STPP was restricted, can be avoided, that is to say, there can be avoided the disadvantages that ions having a large hydrated radius, such as magnesium ions, are scarcely removed, even though the removal ability of calcium ions constituting hardness components from water is excellent because a size of a cavity is constant; and zeolite particles which cause alkality because they are insoluble in water are deposited in fiber gaps, thereby damaging the fiber and affecting humans, and deposited in operating parts of a washing machine, increasing abrasion in the washing machine. Accordingly, layered silicate is in the forefront as a substitute. Furthermore, it is possible to produce a compact detergent according to the world-wide trend, and thus, it attracts considerable attention as an auxiliary substance for detergent capable of contributing to the protection of the environment

Reaction Conditions

(1) Reaction Temperature

In the process according to the present invention, when the sodium bicarbonate aqueous solution reacts with the sodium silicate aqueous solution, a reaction temperature is preferably about 100° C. or above. The reason for this is that when the reaction temperature is about 100° C. or below, the yield of layered silicate may be significantly reduced. On the other hand, when the temperature is about 150° C. or above, layered silicate is generated but sodium sesquicarbonate may be decomposed Accordingly, it is preferable that the reaction temperature of the sodium bicarbonate and sodium silicate aqueous solutions of the present invention be about 100-150° C.

(2) Reaction Time

Reaction time of the sodium bicarbonate and sodium silicate aqueous solutions depend on temperature, and may be easily determined through repeated experimentation incurring no expenses to those skilled in the art. According to a preferred aspect of the present invention, when the reaction is carried out at 125° C. for 1-1.5 hours, a high yield results.

Drying Conditions

Slurry of sodium bicarbonate and sodium silicate mixed according to the present invention may be conveniently dried by heating. Alternatively, drying may be conducted in spray and belt manners, which are well known in the art and may be desirably applied to the present invention. Heat-drying according to the present invention is carried out at 60-70° C. for 48 hours. However, in the case of mass-production, it is preferable to conduct dining in the spray manner rather than the heat-drying manner.

Reaction Mechanism

The reaction of sodium bicarbonate and sodium silicate by heating in an aqueous solution is achieved according to the following Reaction Equations.

First, sodium bicarbonate reacts according to the following Reaction Equations.
NaHCO₃→Na⁺+HCO₃— Reaction Equation 1
2HCO₃—→H₂O+CO₂ Reaction Equation 2

The above reactions scarcely occur in the aqueous solution at room temperature, but are actively carried out at 60° C. or above.

CO₂ generated in Reaction Equations 1 and 2 reacts with sodium silicate as follows. At this time, CO₂ is a main component initiating a reaction of Reaction Equation 3.
Na₂O.2SiO₂+CO₂+4H₂O→Na₂CO₃+2Si(OH)₄ Reaction Equation 3

wherein, Na₂CO₃ reacts with water to produce Na₂CO₃.H₂O.
Na₂CO₃+H₂O→Na₂CO₃. H₂O Reaction Equation 4

Na₂CO₃.H₂O produced through Reaction Equation 3 reacts with NaHCO₃ which is not decomposed by Reaction Equations 1 and 2 to produce a product of Reaction Equation 5.
Na₂CO₃.H₂O+NaHCO₃+H₂O→Na₂CO₃.NaHCO₃.2H₂O Reaction Equation 5

Sodium sesquicarbonate is produced in Reaction Equation 5, and a combination of Reaction Equations 4 and 5 is as follows.
Na₂CO₃+NaHCO₃+2H₂O→Na₂CO₃.NaHCO₃.2H₂O Reaction Equation 6

Since Si(OH)₄ produced in Reaction Equation 3 is very unstable, it is combined with other Si(OH)₄ to form disilicic acid.

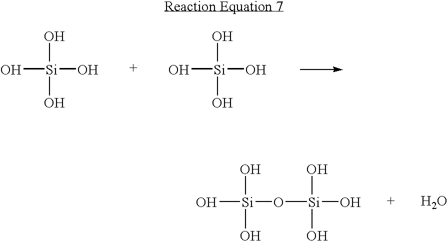

Disilicic acid of Reaction Equation 7 is combined with Na⁺ ions existing in an excessive amount in Reaction Equation 1 to produce layered silicate. In this regard, when the temperature is 100° C. or below, layered silicate is not produced. If anhydrous soda ash is applied to this reaction, the amount of soda ash is excessively increased in conjunction with soda ash generated from sodium silicate according to a reaction mechanism, and thus, a portion of anhydrous soda ash which does not participate in a sodium sesquicarbonate combination is generated in an excessive amount. Additionally, a probability of a reverse reaction of Reaction Equation 3 increases.

Comparison of Conventional Technologies with the Present Invention

The process of the present invention and a process according to JP007322A2 are similar to each other in that a reaction is conducted in a similar temperature condition, but are largely different from each other in that anhydrous soda ash is used instead of sodium bicarbonate, a seed nucleus is used, and sodium sesquicarbonate is not used in the Japanese patent.

Furthermore, when the process of the present invention is compared to that of Korean Pat. Laid-Open Publication No. 2001-0082782, the Korean patent is different from the present invention in that anhydrous soda ash is used as a main raw material in preparation of a mixed solution of anhydrous soda ash and sodium bicarbonate, and a reaction is conducted using a seed nucleus. Additionally, in the Korean patent, sodium sesquicarbonate does not exist but hydrated soda ash is present in a great amount in an upper solution, and a small amount of layered silicate and sodium sesquicarbonate are detected in a lower solution. During operation of a reactor, since three different phases are formed in the reactor, a very low yield results, and three phases separated from each other negatively affect the process.

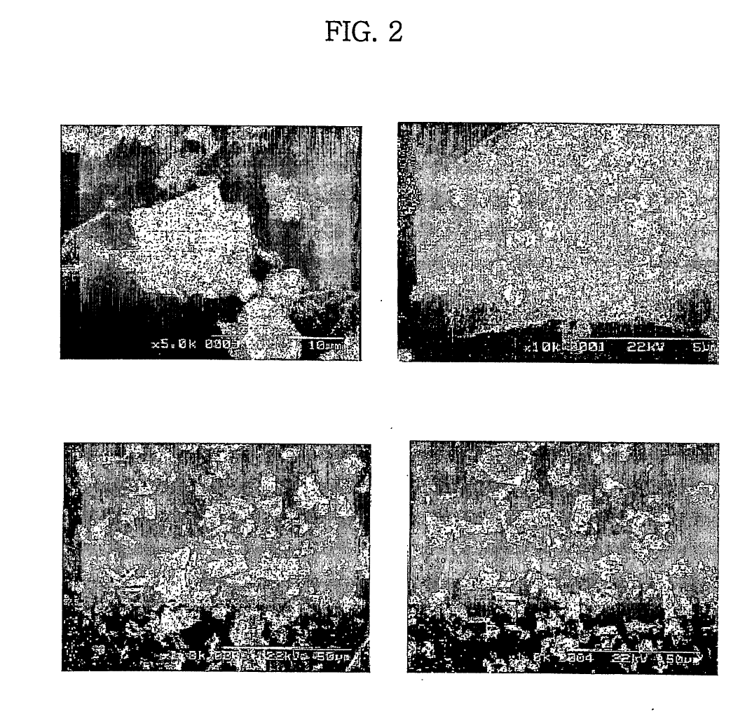

As well, if the seed nucleus is used, it is known that a size of a crystal is 100-200 μm. On the other hand, in the present invention, the seed nucleus is not used, and thus, the size of the crystal is 10-50 μm as shown in a SEM picture of FIG. 2.

The Others

Sodium bicarbonate and sodium silicate may be separately produced in aqueous solution and then mixed with each other, or sodium bicarbonate and sodium silicate may be added into water to initiate the reaction before they are produced in separate aqueous solutions. However, the latter is disadvantageous in that it is difficult to conduct the reaction and the yield may be reduced when they are produced in a great amount.

A better understanding of the present invention may be obtained through the following examples and experimental examples which are set forth to illustrate, but are not to be construed as the limit of the present invention.

### EXAMPLE 1

27.3 g of sodium bicarbonate was mixed with 15 ml of water to produce a homogeneous solution, 72.7 g of first liquid sodium silicate (SiO₂:Na₂O=2.11:1) was mixed with 75 ml of water, and the resulting solutions reacted with each other in a reactor at 125° C. for 1.5 hours to produce slurry containing 50-70% of water. The slury was dried at 60-65° C. for 48 hours to produce white powder.

### EXAMPLE 2

34.5 g of sodium bicarbonate was mixed with 200 ml of water to produce a homogeneous solution, 65.5 g of first liquid sodium silicate (SiO₂:Na₂O=2.11:1) was mixed with 75 ml of water, and the resulting solutions reacted with each other in a reactor at 125° C. for 1.5 hours to produce slurry containing 50-70% of water. The slurry was dried to produce powder at 60-65° C. for 48 hours.

### EXAMPLE 3

37.6 g of sodium bicarbonate was mixed with 30 ml of water to produce a homogeneous solution, 62.4 g of first liquid sodium silicate (SiO₂:Na₂O=2.11:1) was mixed with 75 ml of water, and the resulting solutions reacted with each other in a reactor at 125° C. for 1.5 hours to produce slurry containing 50-70% of water. The slurry was dried to produce powder at 60-65° C. for 48 hours.

### EXAMPLE 4

42.9 g of sodium bicarbonate was mixed with 30 ml of water to produce a homogeneous solution, 57.1 g of first liquid sodium silicate (SiO₂:Na₂O=2.11:1) was mixed with 60 ml of water, and the resulting solutions reacted with each other in a reactor at 125° C. for 1.5 hours to produce slurry containing 50-70% of water. The slurry was dried to produce powder at 60-65° C. for 48 hours.

### EXAMPLE 5

38.5 g of sodium bicarbonate was mixed with 30 ml of water to produce a homogeneous solution, 61.5 g of second liquid sodium silicate (SiO₂:Na₂O=2.35:1) was mixed with 70 ml of water, and the resulting solutions reacted with each other in a reactor at 125° C. for 1.5 hours to produce slurry containing 50-70% of water. The slurry was dried to produce powder at 60-65° C. for 48 hours.

### EXAMPLE 6

35.7 g of sodium bicarbonate was mixed with 20 ml of water to produce a homogeneous solution, 64.3 g of third liquid sodium silicate (SiO₂:Na₂O=3.21:1) was mixed with 70 ml of water, and the resulting solutions reacted with each other in a reactor at 125° C. for 1.5 hours to produce slurry containing 50-70% of water. The slurry was dried to produce powder at 60-65° C. for 48 hours.

### EXAMPLE 7

33.2 g of sodium bicarbonate was mixed with 20 ml of water to produce a homogeneous solution, 66.8 g of fourth liquid sodium silicate (SiO₂:Na₂O=3.76:1) was mixed with 70 ml of water, and the resisting solutions reacted with each other in a reactor at 125° C. for 1.5 hours to produce slurry containing 50-70% of water. The slurry was dried to produce powder at 60-65° C. for 48 hours.

### EXPERIMENTAL EXAMPLE

Powder samples produced according to examples 1 to 7 were analyzed using an XRD, proving that sodium sesquicarbonate (d=3.06 Å, 2.66 Å 2θ=29.17°, 33.67°) appeared, α-Na₂Si₂O₅(d=3.29 Å, 2θ=27°), β-Na₂Si₂O₅(d=2.98 Å, 2.43 Å 2θ=30°, 37°), and δ-Na₂Si₂O₅(d=3.96 Å, 2.43 Å 2θ=22.4°, 37°) existed (FIG. 1).

Furthermore, a crystalline structure was analyzed by SEM resulting in the finding that sodium sesquicarbonate had desirable qualities of crystalline structure, particle size and density, and apparently confirming a structure of layered silicate (FIG. 2).

The present invention has been described in an illustrative manner, and it is to be understood that the terminology used is intended to be in the nature of description rather than of limitation. Many modifications and variations of the present invention are possible in light of the above teachings. Therefore, it is to be understood that within the scope of the appended claims, the invention may be practiced otherwise than as specifically described.

### INDUSTRIAL APPLICABILITY

The present invention provides a process which is capable of simultaneously producing sodium sesquicarbonate and layered silicate easily at high yield. Furthermore, sodium sesquicarbonate contained in powder produced according to the process of the present invention has desirable quality regarding crystalline structure, particle size and density.

1. A process of producing powder including sodium sesquicarbonate and layered silicate, comprising:
(a) mixing a sodium silicate aqueous solution with a separately prepared sodium bicarbonate aqueous solution to produce a reaction solution;
(b) heating the reaction solution to form slurry; and
(c) drying the slurry to produce the powder.

2. The process as set forth in claim 1, wherein a ratio of SiO₂:Na₂O of sodium silicate in the step of (a) is 2.1:1-3.8:1.

3. The process as set forth in claim 1, wherein the step of (b) is conducted at 100-150° C.

4. The process as set forth in claim 1 or 3, wherein the slurry contains 50-70% of water in the step of (b).

5. A process of producing powder including sodium sesquicarbonate and layered silicate, comprising:
(a) mixing sodium silicate, sodium bicarbonate, and water with each other to produce a reaction solution;
(b) heating the reaction solution to form slurry; and
(c) drying the slurry to produce the powder.

6. The process as set forth in claim 5, wherein a ratio of SiO₂:Na₂O of sodium silicate in the step of (a) is 2.1:1-3.8:1.

7. The process as set forth in claim 5, wherein the step of (b) is conducted at 100-150° C.

8. The process as set forth in claim 5 or 7, wherein the slurry contains 50-70% of water in the step of (b).
